(19) United States
(12) Patent Application Publication
(10) Pub. No.: US 2024/0284480 A1
(43) Pub. Date: Aug. 22, 2024

(54) RESOURCE RESERVATION PRIORITIZATION FOR SIDELINK COMMUNICATIONS

(71) Applicant: QUALCOMM Incorporated, San Diego, CA (US)

(72) Inventors: Tien Viet NGUYEN, Bridgewater, NJ (US); Sourjya DUTTA, San Diego, CA (US); Gabi SARKIS, San Diego, CA (US); Hui GUO, Beijing (CN); Shijun WU, San Diego, CA (US); Kapil GULATI, Belle Mead, NJ (US)

(21) Appl. No.: 18/568,198

(22) PCT Filed: Aug. 6, 2021
(86) PCT No.: PCT/CN2021/111118

§ 371 Date: Dec. 7, 2023

(51) Int. Cl. H04W 72/25; H04W 28/26; H04W 72/02; H04W 72/563

(52) U.S. Cl. CPC H04W 72/25; H04W 28/26; H04W 72/02; H04W 72/563

(57) ABSTRACT

Methods, systems, and devices for wireless communication are described. In some examples, a sidelink user equipment (UE) may be configured with one or more prioritization rules for sidelink resource reservation forwarding. The UE monitor for one or more sidelink messages that indicate a set of sidelink resource reservations associated with one or more other UEs. In some examples, the UE may receive a sidelink message and one or more other sidelink messages that indicate reservations of other sidelink resources associated with other UEs. The UE may select one or more sets of sidelink resources for indicating in a coordination message in accordance with the one or more prioritization rules for sidelink resource reservation and based on the sidelink messages. The UE may transmit the coordination message including an indication of the one or more sets of sidelink resources based on the selecting.

### CROSS REFERENCE

The present Application is a 371 national stage filing of International PCT Application No. PCT/CN2021/111118 by NGUYEN et al. entitled “RESOURCE RESERVATION PRIORITIZATION FOR SIDELINK COMMUNICATIONS,” filed Aug. 6, 2021, which is assigned to the assignee hereof, and which is expressly incorporated by reference in its entirety herein.

### FIELD OF TECHNOLOGY

The following relates to wireless communication, including resource reservation prioritization for sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a sidelink UE may operate according to a sidelink resource allocation mode 2, in which the UE may autonomously (e.g., without signaling from a base station) perform sidelink resource selection and reservation. A transmitting UE may select resources for a future sidelink transmission and broadcast a self-reservation message indicating that the selected resources are reserved. However, some nearby UEs may not receive the self-reservation message.

### SUMMARY

The described techniques relate to improved methods, systems, devices, and apparatuses that support resource reservation prioritization for sidelink communications. Generally, the described techniques provide for a user equipment (UE) to be configured with one or more prioritization rules for sidelink resource reservation forwarding. The UE may communicate with one or more other UEs according to a sidelink resource allocation mode 2, in which the one or more UEs may autonomously perform sidelink resource reservation and allocation. For example, the UE may monitor for a sidelink message that indicates reservation of a set of sidelink resources associated with one or more other UEs. The UE may receive the sidelink message and one or more other sidelink messages indicating other reservations of sidelink resources associated with other UEs.

The UE may forward an indication of one or more of the reservations to other UEs. The UE may select one or more sets of sidelink resources for indicating in a coordination message based on the one or more prioritization rules for sidelink resource reservation forwarding. In some examples, the prioritization rules may indicate rules for selecting the one or more sets of sidelink resources based on a scheduled transmission time associated with the one or more sets of sidelink resources, based on a UE processing time, based on a time at which the sidelink messages indicating the resource reservations are received, based on a number of times the resource reservations have been forwarded by other UEs, based on one or more thresholds, or any combination thereof. The UE may transmit the coordination message including an indication of the one or more sets of sidelink resources based on the selecting. In some examples, the UE may broadcast the coordination message to one or more other UEs. The UE may thereby efficiently select which resource reservation information to include in a coordination message based on the prioritization rules, which may improve utilization of communication resources and coordination between UEs.

A method for wireless communication at a first UE is described. The method may include monitoring for one or more sidelink messages that indicate a set of sidelink resource reservations associated with one or more second UEs, selecting one or more sets of sidelink resource reservations for indicating in a coordination message in accordance with one or more prioritization rules for sidelink resource reservation forwarding based on a sidelink message of the one or more sidelink message, and transmitting the coordination message including an indication of the one or more sets of sidelink resource reservations based on the selecting.

An apparatus for wireless communication at a first UE is described. The apparatus may include a processor, memory coupled with the processor, and instructions stored in the memory. The instructions may be executable by the processor to cause the apparatus to monitor for one or more sidelink messages that indicate a set of sidelink resource reservations associated with one or more second UEs, select one or more sets of sidelink resource reservations for indicating in a coordination message in accordance with one or more prioritization rules for sidelink resource reservation forwarding based on a sidelink message of the one or more sidelink message, and transmit the coordination message including an indication of the one or more sets of sidelink resource reservations based on the selecting.

Another apparatus for wireless communication at a first UE is described. The apparatus may include means for monitoring for one or more sidelink messages that indicate a set of sidelink resource reservations associated with one or more second UEs, means for selecting one or more sets of sidelink resource reservations for indicating in a coordination message in accordance with one or more prioritization rules for sidelink resource reservation forwarding based on a sidelink message of the one or more sidelink message, and means for transmitting the coordination message including an indication of the one or more sets of sidelink resource reservations based on the selecting.

A non-transitory computer-readable medium storing code for wireless communication at a first UE is described. The code may include instructions executable by a processor to monitor for one or more sidelink messages that indicate a set of sidelink resource reservations associated with one or more second UEs, select one or more sets of sidelink resource reservations for indicating in a coordination message in accordance with one or more prioritization rules for sidelink resource reservation forwarding based on a sidelink message of the one or more sidelink message, and transmit the coordination message including an indication of the one or more sets of sidelink resource reservations based on the selecting.

In some examples of the method, apparatuses, and non-transitory computer-readable medium described herein, selecting the one or more sets of sidelink resource reservations may include operations, features, means, or instructions for selecting, in accordance with the one or more prioritization rules, the one or more sets of sidelink resource reservations based on a scheduled transmission time associated with the one or more sets of sidelink resource reservations, where the sidelink message indicates the scheduled transmission time.

In some examples of the method, apparatuses, and non-transitory computer-readable medium described herein, selecting the one or more sets of sidelink resource reservations may include operations, features, means, or instructions for selecting, in accordance with the one or more prioritization rules, the one or more sets of sidelink resource reservations based on a difference between the scheduled transmission time and a delay period being greater than a threshold difference, the delay period based on a UE processing time and a first time associated with the selecting.

In some examples of the method, apparatuses, and non-transitory computer-readable medium described herein, the one or more sets of sidelink resource reservations exclude a first set of sidelink resources based on a difference between a second scheduled transmission time associated with the first set of sidelink resource reservations and a delay period being less than zero, the delay period based on a UE processing time and a first time associated with the selecting.

In some examples of the method, apparatuses, and non-transitory computer-readable medium described herein, a UE processing time associated with the UE may be based on a time for the UE to process the sidelink coordination message and a type of signal used to convey the sidelink coordination message.

In some examples of the method, apparatuses, and non-transitory computer-readable medium described herein, selecting the one or more sets of sidelink resource reservations may include operations, features, means, or instructions for selecting at least a set of sidelink resource reservations based on the sidelink message that indicates the set of sidelink resource reservations being received after other sidelink messages that indicate other sets of sidelink resource reservations.

In some examples of the method, apparatuses, and non-transitory computer-readable medium described herein, selecting the one or more sets of sidelink resource reservations may include operations, features, means, or instructions for selecting at least a set of sidelink resource reservations based on a first slot in which the sidelink message that indicates the set of sidelink resource reservations may be received being less than a threshold time period from a second slot in which the coordination message may be scheduled.

In some examples of the method, apparatuses, and non-transitory computer-readable medium described herein, selecting the one or more sets of sidelink resource reservations may include operations, features, means, or instructions for selecting at least a set of sidelink resource reservations based on a first slot in which the sidelink message that indicates the set of sidelink resource reservations may be received being less than a threshold time period from a second slot that corresponds to a time at which the UE selects the set of sidelink resource reservations for indicating in the coordination message.

In some examples of the method, apparatuses, and non-transitory computer-readable medium described herein, selecting the one or more sets of sidelink resource reservations may include operations, features, means, or instructions for selecting at least a set of sidelink resource reservations based on a value of a new data indicator (NDI) in the sidelink message that indicates the set of sidelink resource reservations being set to one, where the NDI set to one indicates that the set of sidelink resource reservations may be a first reservation of a set of sidelink resources used to transmit a sidelink communication.

In some examples of the method, apparatuses, and non-transitory computer-readable medium described herein, the sidelink message that indicates the one or more sets of sidelink resource reservations may be received via sidelink control information (SCI).

Some examples of the method, apparatuses, and non-transitory computer-readable medium described herein may further include operations, features, means, or instructions for receiving the one or more sidelink messages from the one or more second UEs, the one or more sidelink messages including inter-UE coordination messages.

Some examples of the method, apparatuses, and non-transitory computer-readable medium described herein may further include operations, features, means, or instructions for monitoring a quantity of times a set of sidelink resource reservations may be forwarded via the inter-UE coordination messages and selecting at least the set of sidelink resource reservations based on the quantity being less than a threshold quantity.

Some examples of the method, apparatuses, and non-transitory computer-readable medium described herein may further include operations, features, means, or instructions for selecting the set of sidelink resource reservation based on the quantity being greater than or equal to one.

In some examples of the method, apparatuses, and non-transitory computer-readable medium described herein, transmitting the coordination message may include operations, features, means, or instructions for transmitting the coordination message via a physical sidelink shared channel (PSSCH), where a quantity of the one or more sets of sidelink resource reservations indicated via the coordination message may be based on a quantity of available resources in the PSSCH.

In some examples of the method, apparatuses, and non-transitory computer-readable medium described herein, transmitting the coordination message may include operations, features, means, or instructions for transmitting the coordination message via radio resource control (RRC) signaling, a medium access control-control element (MAC-CE), SCI, or a combination thereof.

### BRIEF DESCRIPTION OF THE DRAWINGS

FIGS. 1 and 2 illustrate examples of wireless communications systems that support resource reservation prioritization for sidelink communications in accordance with aspects of the present disclosure.

FIG. 3 illustrates an example of a resource diagram that supports resource reservation prioritization for sidelink communications in accordance with aspects of the present disclosure.

FIG. 4 illustrates an example of a process flow that supports resource reservation prioritization for sidelink communications in accordance with aspects of the present disclosure.

FIGS. 5 and 6 show block diagrams of devices that support resource reservation prioritization for sidelink communications in accordance with aspects of the present disclosure.

FIG. 7 shows a block diagram of a communications manager that supports resource reservation prioritization for sidelink communications in accordance with aspects of the present disclosure.

FIG. 8 shows a diagram of a system including a device that supports resource reservation prioritization for sidelink communications in accordance with aspects of the present disclosure.

FIGS. 9 through 11 show flowcharts illustrating methods that support resource reservation prioritization for sidelink communications in accordance with aspects of the present disclosure.

### DETAILED DESCRIPTION

Some wireless communications systems may support sidelinks for communications between communication devices. Sidelinks may refer to any communication link between similar communication devices such as user equipments (UEs). It is noted that while various examples provided herein are discussed for UE sidelink devices, such sidelink techniques may be used for any type of wireless devices that use sidelink communications. For example, a sidelink may support one or more of device-to-device (D2D) communications, vehicle-to-everything (V2X) or vehicle-to-vehicle (V2V) communications, message relaying, discovery signaling, beacon signaling, or other signals transmitted over-the-air from one UE to one or more other UEs.

In some wireless communications systems, one or more sidelink UEs may operate according to a sidelink resource allocation mode 2, in which the UEs may autonomously perform sidelink resource reservation without scheduling from a base station. A transmitting UE (e.g., a UE that has a data packet to transmit to one or more other UEs) may select resources for a sidelink transmission and broadcast a reservation message to indicate that the selected resources are reserved by the transmitting UE. The reservation message may be included in the control part of a data transmission. In another case, the reservation message can be included in a coordination massage to assist other UEs with their resource selection process. The reservation message may, in some examples, not be received by all other nearby UEs. For example, the reservation message may collide with another reservation message, or may be subject to other interference. To improve coverage of the reservation message, some UEs that receive the reservation message may forward the indication of the reserved resources to other UEs via a coordination message (which may be referred to as a self-reservation message, an inter-UE coordination message, or both). However, a UE may receive multiple reservation messages or coordination messages, and the UE may not be configured with rules for determining which resource reservations to forward.

Techniques, systems, and devices are described herein for improving sidelink resource reservation and selection schemes by configuring sidelink UEs with one or more rules for prioritizing resource reservation information and selecting which resource reservation information to forward to other UEs. The one or more rules may be referred to as prioritization rules for sidelink resource reservation forwarding. In one example, the prioritization rules may instruct a UE to prioritize reserved resources based on a scheduled transmission time associated with the reserved resources. For example, if a UE receives a coordination message indicating a set of reserved resources that are configured with a transmission time that has already occurred, or occurs before the other UE has time to process the coordination message, the UE may refrain from forwarding the resource reservation information. The UE may prioritize other resource reservations with transmission times that are further in the future, or are greater than a threshold.

In another example, the prioritization rules may instruct the UE to prioritize resource reservations received more recently by the UE than other resource reservations. For example, the UE may be configured with a cutoff time period, and the UE may refrain from retransmitting resource reservation information received prior to the cutoff time period. Additionally or alternatively, the prioritization rules may indicate a prioritization of resource reservation information that has been forwarded by other UEs less than a threshold number of times (e.g., two times or less). The UE may select which resource reservations to forward to other UEs in a coordination message based on the prioritization of the resource reservations. The prioritization rules may thereby indicate which reserved resources to indicate via a coordination message, which may provide for efficient utilization of communication resources and improved communication reliability.

Aspects of the disclosure are initially described in the context of wireless communications systems. Additional aspects of the disclosure are described with reference to a resource diagram and a process flow. Aspects of the disclosure are further illustrated by and described with reference to diagrams, system diagrams, and flowcharts that relate to resource reservation prioritization for sidelink communications.

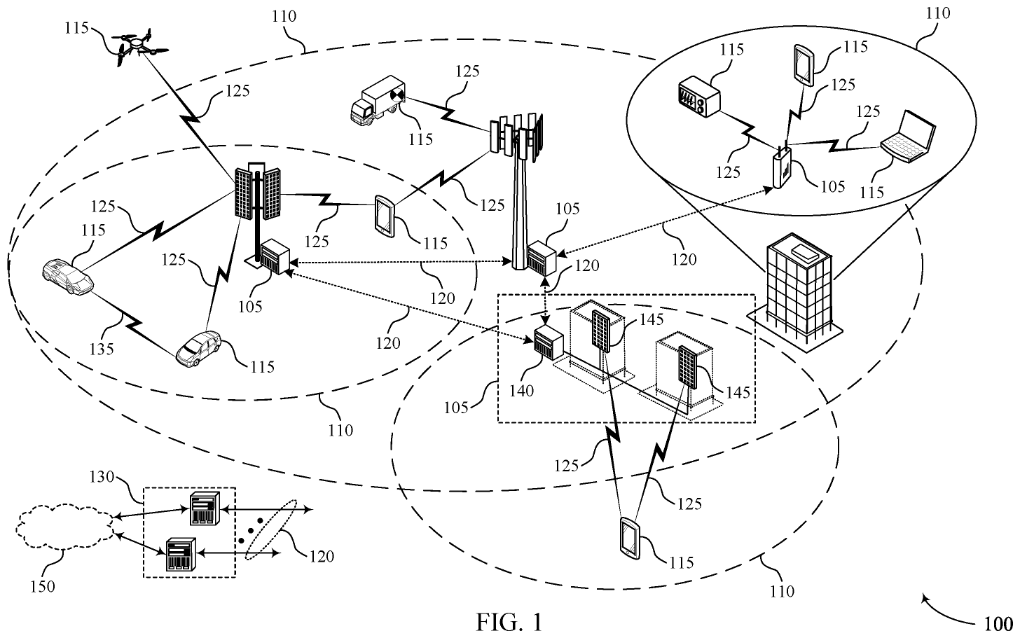

FIG. 1 illustrates an example of a wireless communications system 100 that supports resource reservation prioritization for sidelink communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a D2D communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using V2X communications, V2V communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 may be configured with one or more prioritization rules for sidelink resource reservation forwarding. The UE 115 may communicate with one or more other UEs 115 according to a sidelink resource allocation mode 2, in which the one or more UEs 115 may autonomously perform sidelink resource reservation and allocation. For example, the UE 115 may monitor for a sidelink message that indicates reservation of a set of sidelink resources associated with one or more other UEs 115. The UE 115 may receive the sidelink message and one or more other sidelink messages indicating other reservations of sidelink resources associated with other UEs 115.

The UE 115 may forward an indication of one or more of the reservations to other UEs 115. The UE 115 may select one or more sets of sidelink resources for indicating in a coordination message based on the one or more prioritization rules for sidelink resource reservation forwarding. In some examples, the prioritization rules may indicate rules for selecting the one or more sets of sidelink resources that are reserved by other UEs 115 based on a scheduled transmission time associated with the one or more sets of reserved sidelink resources, based on a UE processing time, based on a time at which the sidelink messages indicating the resource reservations are received, based on a number of times the resource reservations have been forwarded by other UEs 115, based on one or more thresholds, or any combination thereof. The UE 115 may transmit the coordination message including an indication of the one or more sets of reserved sidelink resources based on the selecting. In some examples, the UE 115 may broadcast the coordination message to one or more other UEs 115. The UE 115 may thereby efficiently select which resource reservation information to include in a coordination message based on the prioritization rules, which may improve utilization of communication resources and coordination between sidelink UEs 115.

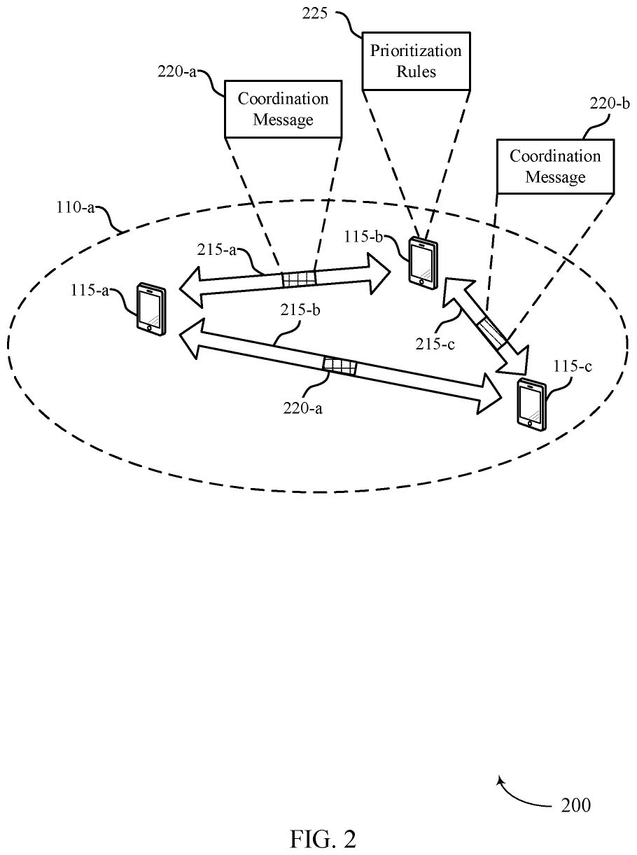

FIG. 2 illustrates an example of a wireless communications system 200 that supports resource reservation prioritization for sidelink communications in accordance with aspects of the present disclosure. The wireless communications system 200 may implement aspects of the wireless communications system 100 or may be implemented by aspects of the wireless communications system 100. For example, the wireless communications system 200 may include UEs 115-a, 115-b, and 115-c (e.g., among other UEs 115), which may represent examples of UEs 115 as described with reference to FIG. 1. The UEs 115-a, 115-b, and 115-c may communicate with each other within a geographic coverage area 110-a and via sidelink communication links 210 (e.g., the sidelink communication links 210-a, 210-b, and 210-c). In some examples, the UEs 115 may perform sidelink resource selection and reservation based on one or more coordination messages 220.

The UEs 115-a, 115-b, and 115-c may support a sidelink resource allocation mode 2. While operating according to the sidelink resource allocation mode 2, the UEs 115 may autonomously perform sidelink resource selection and reservation without scheduling by a base station 105. For example, if a transmitting UE 115 has a sidelink data packet to transmit, the transmitting UE 115 will select a set of sidelink resources for transmitting the sidelink data packet. The UE 115 may select the resources based on monitoring for sidelink control information (SCI) or other sidelink messages from one or more other UEs 115 that indicate resource reservation information.

The resource reservation information may be conveyed via coordination messages 220 (e.g., inter-UE coordination messages or self-reservation messages), SCI, or some other reservation messages. A coordination message 220 or SCI may indicate one or more resources preferred by a UE 115, one or more resources not preferred by the UE 115, one or more resources in which the UE 115 detects a resource conflict, or any combination thereof. For example, the UE 115-a may have a data packet to transmit to the UE 115-b and the UE 115-c. The UE 115-b and the UE 115-c may transmit, to the UE 115-a, an indication of resources preferred by the UE 115-b and the UE 115-c, respectively (e.g., based on a result of a channel sensing procedure performed by the UEs 115-b and 115-c). The UE 115-a may select resources from the resources preferred by the UE 115-b and the UE 115-c for the sidelink transmission. In some cases, the resources preferred by the UE 115-b may not overlap with the resources preferred by the UE 115-c. As such, if the UE 115-a has a data packet to broadcast to both the UE 115-b and the UE 115-c, the UE 115-a may be unable to select resources preferred by both the UEs 115-b and 115-c for the transmission.

In another example, the UEs 115-b and 115-c may transmit an indication of resources that are not preferred for the sidelink message. For example, the UEs 115-b and 115-c may perform a channel sensing procedure to identify resources that are associated with relatively high interference or potential for resource collisions. The UE 115-a may select a resource that is different from the resources indicated by the UEs 115-b and 115-c for a future sidelink transmission. By receiving an indication of resources that are not preferred by each receiving UE 115, the UE 115-a may select a resource that is supported by multiple UEs 115 for a groupcast or broadcast sidelink transmission.

The UE 115-a may thereby select one or more resources for a future sidelink transmission based on signaling from other UEs 115. In some cases, if the sidelink transmission is not a retransmission (e.g., if the sidelink transmission is a first aperiodic transmission or a first semipersistent scheduling (SPS) transmission), the UE 115-a may not transmit an indication of the selected resources to other UEs 115 prior to the sidelink transmission (e.g., the resources may be selected but not signaled). That is, the UEs 115-b and 115-c, as well as other UEs 115 in the geographic coverage area 110-a, may not know that the UE 115-a has reserved those resources, which may result in potential resource collisions.

To reduce resource collisions, a transmitting UE 115 as described herein may transmit a coordination message 220, a self-reservation message, or another type of reservation message to indicate resources that are reserved by the UE 115. For example, if the UE 115-a selects resources for a future sidelink transmission, the UE 115-a may broadcast a coordination message 220-a or a self-reservation message to indicate that the selected resources are reserved. In some examples, however, the coordination message 220-a, the self-reservation message or another type of reservation message may not be received by each other UE 115 in the geographic coverage area 110-a. For example, the coordination message 220-a may collide with another sidelink message (e.g., another coordination message 220, self-reservation message, other reservation message, or any combination thereof), and may not be received or decoded by the UE 115-c.

To reduce potential resource collisions and improve resource reservation reliability and coverage of sidelink resource reservations, each sidelink UE 115 may be configured to forward resource reservation information via a coordination message 220. That is, a UE 115 that receives resource reservation information via a coordination message 220 or some other reservation message may forward the resource reservation information to one or more other UEs 115 via a coordination message 220. For example, the UE 115-b may receive the coordination message 220-a including first resource reservation information (e.g., an indication of a first set of resources reserved by the UE 115-a or another UE 115). The UE 115-b may transmit the coordination message 220-b to the UE 115-c and one or more other UEs 115 (e.g., a broadcast transmission) after receiving the coordination message 220-a. The UE 115-b may forward the first resource reservation information via the coordination message 220-b. In some examples, the coordination message 220-b may additionally or alternatively include an indication of resources reserved by the UE 115-b (e.g., self-reservation information), other resource reservation information forwarded from other UEs 115 (e.g., forwarded resource reservation information), or both. In another example, the UE 115-b may receive the first resource reservation information via SCI (e.g., SCI-1), and the UE 115-b may forward the first resource reservation information to the UE 115-c and one or more other UEs 115 via the coordination message 220-b. The coordination messages 220 may be transmitted via SCI (e.g., SCI-1 or SCI-2), via a MAC-CE, or via RRC signaling.

By forwarding resource reservation information, the UEs 115 may reduce resource collisions and improve a rate of sidelink packet reception in the wireless communications system 200. For example, the UE 115-c may not receive the initial indication of a first set of reserved resources via the coordination message 220-a (e.g., due to pathloss, interference, a resource collision, or any combination thereof), but the UE 115-c may receive the coordination message 220-b, which may forward the indication of the first set of reserved resources. Additionally or alternatively, the UE 115-c may not receive the initial indication of the first set of resources via a reservation message (e.g., a self-reservation message or other reservation message transmitted via SCI), but the UE 115-c may receive the coordination message 220-b, which may forward the indication of the first set of reserved resources. As such, the forwarded resource reservation information may improve coordination between the UE 115-a and the UE 115-c and reduce potential for resource collisions.

Each coordination message 220 may include a relatively small payload size, may include a relatively small number of unused resources, or both. For example, the coordination message 220-a may include a first number of resources configured to convey resource reservation information for the UE 115-a, and a second number of unused resources (e.g., resource elements that may carry a physical sidelink shared channel (PSSCH)) which may be a fixed number. The UE 115-a may use the unused resources to forward resource reservation information from other UEs 115. However, the UE 115-a (e.g., and each other UE 115) may receive resource reservations (e.g., via a coordination message 220, a self-reservation message, or another type of reservation message) from multiple other UEs 115 (e.g., 10 UEs 115, or some other number of UEs 115). Due to the fixed capacity of the unused resources in each coordination message 220, the UE 115-a may not be able to forward all of the resource reservation information that the UE 115-a receives. For example, the UE 115-a may fit resource reservation information forwarded from five UEs 115, or some other number of UEs 115 that is less than a number of UEs 115 that transmit resource reservation information to the UE 115-a. In some cases, the UE 115-a may randomly select which resource reservations to forward.

A UE 115 as described herein may be configured with one or more prioritization rules 225 for selecting which resource reservation information to forward to other UEs 115. By selecting which resource reservation information to forward based on the prioritization rules 225, the UE 115 may improve efficient utilization of resources, reduce latency, and reduce interference. For example, the prioritization rules 225 may indicate that the UE 115-b may prioritize reserved resources based on a future transmission time associated with the resources, based on a UE processing time, based on how recently the reservation information was received by the UE 115-b, based on a number of previous retransmissions of the reservation information, based on a number of UEs 115 that have already forwarded the reservation information, or any combination thereof. Each of the UEs 115-a, 115-b, 115-c, and other UEs 115 may be configured with respective prioritization rules 225.

In some examples, a UE 115, such as the UE 115-b, may prepare a coordination message 220 in response to identifying a packet that the UE 115-b has to transmit. That is, the UE 115-b may prepare the coordination message 220-b to indicate self-reservation information for a future transmission by the UE 115-b. If there are unused resources in the coordination message 220-b, the UE 115-b may utilize the prioritization rules 225 to select other resource reservation information that the UE 115-b will forward via the unused resources in the coordination message 220-b. A coordination message 220 that includes self-reservation information may, in some examples, be referred to as a self-reservation message.

Additionally or alternatively, the UE 115-b may determine to transmit the coordination message 220-b to forward resource reservation information. For example, the UE 115-b may receive one or more coordination messages 220, a self-reservation message, or another type of reservation message that indicate resource reservations, such as the coordination message 220-a that indicates resources reserved by the UE 115-a and/or resource reservations forwarded from one or more other UEs 115. The UE 115-b may determine to transmit the coordination message 220-b to forward the resource reservation information. The UE 115-b may select which resource reservation information to include in the coordination message 220-b based on the prioritization rules 225. That is, in some examples, the UE 115-b may transmit the coordination message 220-b regardless of whether the UE 115-b identifies a data packet or has self-reservation information to transmit.

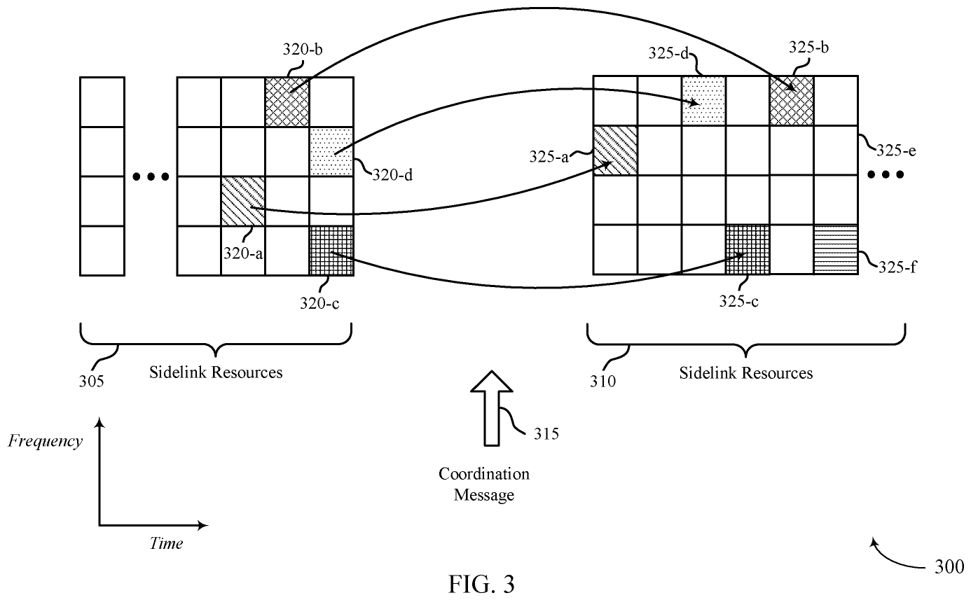

One or more UEs 115 may thereby be configured with prioritization rules 225 for sidelink resource reservation forwarding. The UEs 115 may determine which resource reservations to forward to other UEs 115 based on the prioritization rules 225, which may improve communication reliability, improve efficiency of resource utilization, and reduce latency. Examples of the prioritization rules 225 are described in further detail elsewhere herein, including with reference to FIG. 3.

FIG. 3 illustrates an example of a resource diagram 300 that supports resource reservation prioritization for sidelink communications in accordance with aspects of the present disclosure. The resource diagram 300 may be implemented by aspects of the wireless communications systems 100 and 200 or may implement aspects of the wireless communications systems 100 and 200, as described with reference to FIGS. 1 and 2, respectively. For example, the resource diagram 300 may be implemented by one or more UEs 115 to support sidelink resource reservation forwarding.

The resource diagram 300 depicts a set of sidelink resources 305 and a set of sidelink resource 310. The set of sidelink resources 305 may span a first number of slots in a time domain and a first number of subchannels in a frequency domain, and the set of sidelink resources 310 may span a second number of slots in the time domain and a second number of subchannels in the frequency domain. In some examples, the set of sidelink resources 305 may correspond to a sensing window during which a UE 115 may decode SCI to determine which sidelink resources 325 of the set of sidelink resources 310 are available for reservation. For example, the set of sidelink resources 305 may include SCI 320-a, SCI 320-b, SCI 320-c, and SCI 320-d, which may each reserve one or more sidelink resources 325 of the set of sidelink resource 310. In the example of FIG. 3, the SCI 320-a may reserve the sidelink resource 325-a of the set of sidelink resources 310, the SCI 320-b may reserve the sidelink resource 325-b of the set of sidelink resources 310, the SCI 320-c may reserve the sidelink resource 325-c of the set of sidelink resources 310, and the SCI 320-d may reserve the sidelink resource 325-d of the set of sidelink resources 310.

A UE 115 may monitor the set of sidelink resources 305 for the SCI 320 and may decode one or more of the SCI 320-a, the SCI 320-b, the SCI 320-c, and the SCI 320-d. In some examples, the SCI 320 may be forwarded via a coordination message 315 (e.g., an inter-UE coordination message), which may be an example of a UE coordination message as described with reference to FIG. 2. The SCI 320 may indicate resource reservations for a UE 115 that transmits the SCI 320. The UE 115 may select one or more resources of the set of sidelink resources 310 for a transmission by the UE 115 based on the reserved resources indicated via the SCI 320 from other UEs. For example, the UE 115 may select the sidelink resource 325-f for a sidelink transmission by the UE 115 based on the sidelink resource 325-f not being reserved by any of the SCI received in the set of sidelink resources 305. Although the sidelink resources 305 are illustrated to include the SCI 320, it is to be understood that the UE 115 may monitor the sidelink resources 305 for resource reservation information received via RRC signaling, a MAC-CE, or some other signaling that may indicate a resource reservation.

The UE 115 may transmit a coordination message 315 after monitoring the set of sidelink resources 305. The coordination message 315 may indicate a reservation of the sidelink resource 325-f by the UE 115 (e.g., a self-reservation message). Additionally or alternatively, the coordination message 315 may forward an indication of one or more of the reserved resources indicated via the SCI 320-a, 320-b, 320-c, and 320-d. The UE 115 may generate the coordination message 315 based on identifying a sidelink data packet the UE 115 is to transmit, based on receiving one or more indications of resource reservations, or both. The coordination message 315 may be transmitted via a PSSCH, and a number of PSSCH resources in the coordination message 315 may be fixed such that the UE 115 may not forward each indication of reserved resources that the UE 115 receives. In some cases, the UE 115 may not know which resource reservation information to forward to other UEs 115 via the coordination message 315.

Techniques for forwarding resource reservations are described herein in which the UE 115 may be configured with one or more prioritization rules for sidelink resource reservation forwarding. The prioritization rules may indicate which reserved resources of the one or more reserved resources indicated via the SCI 320 should be forwarded to other UEs 115 via a coordination message 315. By selecting which reserved resources to forward based on the prioritization rules, the UE 115 may improve utilization of communication resources, coordination between devices, and communication reliability.

In one example, the prioritization rules may indicate that the UE 115 should prioritize reserved resources based on a time (e.g., a future time) at which a transmission is scheduled in the reserved resources, which may be referred to as a scheduled transmission time. The one or more rules may indicate that the UE 115 should forward resource reservation information if a difference between the scheduled transmission time and a processing delay (e.g., a reaction time or a delay period) of one or more other UEs 115, such as target UEs 115, is greater than a threshold. The processing delay may correspond to a current time and a delay period during which each UE 115 of the one or more other UEs 115 accounts for resource reservations indicated via the SCI 320 (e.g., other coordination messages) and selects the sidelink resource 325-f or one or more other sidelink resources for a future transmission by the other UE 115. The processing delay period may include a delay for the other UE 115 to process the received information. A duration of the delay may be based on a type of signaling used to transmit the coordination message 315 (e.g., at least a 3 ms processing delay for MAC-CE signaling, at least a 5 ms processing delay for RRC signaling, or some other processing delay duration). Additionally or alternatively, the processing delay period may account for a time in which the UE 115 prepares the coordination message 315 (e.g., a 2 ms processing delay, or some other duration). For example, if the coordination message 315 is transmitted via SCI (e.g., SCI-1 or SCI-2), the processing delay may be relatively small (e.g., the information may be available within a next slot), but a capacity of the SCI may be relatively small (e.g., 144 bits, or some other capacity). If the coordination message 315 is transmitted via RRC signaling or a MAC-CE, the capacity may be larger than the SCI capacity, but the processing delay may be longer (e.g., a 5 ms delay for MAC-CE signaling, a 7 ms delay for RRC signaling, or some other total processing delay).

In the example of FIG. 3, the UE 115 may receive the SCI 320-a at a first time, and the SCI 320-a may reserve the sidelink resource 325-a, which may be associated with a transmission time, T_{reserved}. The UE 115 may be configured to support a first processing time, T_{processing}. The prioritization rules may indicate that UE 115 should forward the reservation information via the coordination message 315 if the difference between the transmission time and a current time, T_{current}, in addition to the UE processing time is greater than a threshold (e.g., if T_{reserved}−(T_{current}+T_{processing})>T_{threshold} the UE 115 may forward the reservation information). If the transmission time satisfies the threshold, the UE 115 will forward an indication of the reservation of the sidelink resource 325-a to one or more other UEs 115 via the coordination message 315.

The prioritization rules may indicate that if the UE 115 receives resource reservation information associated with a transmission time that occurs before the UE 115 can process the SCI 320-a (e.g., if T_{reserved}−(T_{current}+T_{processing})<T_{threshold}, where T_{threshold} may be zero, or some other number), the UE 115 should refrain from retransmitting the resource reservation information. For example, the UE 115 may not forward the indication of the reservation of the sidelink resource 325-a via the coordination message 315. In some examples, each UE 115 in a network may be associated with a respective UE processing time. In such cases, the threshold processing time, T_{processing}, indicated by the prioritization rules may be an upper bound of the processing delays that may be utilized by each UE 115 in the network for determining whether to forward resource reservation information. Additionally or alternatively, some UEs 115 may be configured to forward resource reservation information if T_{reserved}−(T_{current}+T_{processing})<T_{threshold}. For example, some UEs 115 that support processing times that are shorter than the threshold processing time (e.g., the upper bound) may be configured to forward the resource reservation information. The prioritization rules may permit such resource reservation information forwarding based on a priority, a cast type (e.g., if the resource reservation information is for a unicast packet from an intended transmitter), an amount of available space in a coordination message, or any combination thereof.

Additionally or alternatively, the prioritization rules may indicate that the UE 115 should prioritize resource reservation information that is associated with a transmission time that is furthest in the future, and the UE 115 should select which information to forward based on the prioritizing. In other words, the UE 115 may generate a prioritized list of resource reservation information that is ordered based on scheduled transmissions times, and the UE 115 may select a first set of resource reservation information from the top of the prioritized list. In the example of FIG. 3, the SCI 320-b may indicate a reservation of the sidelink resource 325-b, which may be associated with a transmission time that is further in the future than the sidelink resources 325-a, 325-c, and 325-d. As such, the UE 115 may forward the reservation of the sidelink resource 325-b via the coordination message 315.

In another example, the prioritization rules may indicate that the UE 115 should prioritize resource reservation information based on a time at which the resource reservation information is received by the UE 115. That is, the UE 115 may generate a prioritized list of resource reservation information, where resource reservation information that was received most recently is prioritized in the list (e.g., the most up to date information). The UE 115 may select a set of resource reservation information to forward based on the list (e.g., a first few entries in the list, based on a capacity of the coordination message 315). The prioritization rules may thereby indicate that the UE 115 should forward recently received resource reservation information and refrain from forwarding older resource reservation information. In the example of FIG. 3, the SCI 320-d and the SCI 320-c may be received more recently by the UE 115 than the SCI 320-a and the SCI 320-b. The UE 115 may forward the reservations of the sidelink resources 325-d and 325-c via the coordination message 315 based on the reservation information being received most recently by the UE 115.

Additionally or alternatively, the UE 115 may be configured with a threshold cutoff time, T_{cutoff}, (e.g., the UE 115 may be pre-configured with the threshold cutoff time or may receive control signaling indicating the threshold cutoff time). The prioritization rules may indicate that the UE 115 should refrain from forwarding any resource reservation information that is older than the threshold cutoff time. In one example, the threshold cutoff time may be defined relative to a slot on which the resource reservation information is received and a slot that corresponds to a time at which the UE 115 selects which resource reservation information to forward (e.g., a current slot). That is, if the slot on which the resource reservation information was received is more than the threshold cutoff time from a current slot, the UE 115 may refrain from forwarding the resource reservation information. In another example, the threshold cutoff time may be defined relative to a slot in which the resource reservation information is received and a slot for transmission of the coordination message 315. That is, if the UE 115 intends to transmit the coordination message 315 in a second slot, and the UE 115 received the resource reservation information in a first slot that is more than the threshold cutoff time from the second slot, the UE 115 will refrain from forwarding the resource reservation information via the coordination message 315.

In another example, the prioritization rules may indicate that the UE 115 should select resource reservation information to forward based on a number of times the resource reservation information has been retransmitted. For example, the one or more rules may configure the UE 115 to prioritize resource reservation information that has been forwarded one or two times (e.g., or some other number of times that is less than a threshold). A first transmission of resource reservation information may be received and decoded by a first number of UEs 115 (e.g., ten UEs 115, or some other number). A first retransmission of the resource reservation information may be received and decoded by a second number of UEs 115 that did not receive the first transmission, and the second number may, in some examples, be less than the first number (e.g., five UEs 115, or some other number of UEs 115). A second retransmission of the resource reservation information may be received and decoded by a third number of UEs 115 that have not yet received the information and the third number may be less than the first and second numbers. In other words, a first transmission or a first few retransmissions may reduce potential for interference more than later retransmissions. As such, the UE 115 may refrain from forwarding resource reservation information that has been forwarded more than a threshold number of times.

The UE 115 may determine whether resource reservation information received via the SCI 320 includes resource reservation information that has previously been retransmitted based on a value of a new data indicator (NDI) in the SCI 320 (e.g., an SCI-2 message). When a new data packet is transmitted, a bit in the NDI field will be set (e.g., to ‘1’). As such, if the UE 115 receives an SCI 320 with the NDI bit set, the UE 115 will determine that the reservation information conveyed via the SCI 320 has not been retransmitted before (e.g., the resource reservation information is new information), and the UE 115 will forward the resource reservation information accordingly. For example, the SCI 320-a may include an NDI bit that is set, and the UE 115 may forward the reservation of the sidelink resource 325-a via the coordination message 315 based on the NDI bit being set in the SCI 320-a.

Additionally or alternatively, the UE 115 may count a number of times the resource reservation information has been forwarded since the UE 115 identified the NDI bit being set, and the UE 115 may forward the resource reservation if the number of forwards is less than a threshold number. For example, the UE 115 may receive a first SCI 320 (not pictured) that indicates a reservation of the sidelink resource 325-a and includes an NDI bit that is set. The UE 115 may monitor each other SCI 320 in the set of sidelink resources 305 received after the first SCI 320 and determine how many of the SCI 320 indicate a reservation of the sidelink resource 325-a. If the number of SCI 320 that indicate the reservation of the sidelink resource 325-a is greater than the threshold number, the UE 115 will refrain from forwarding the reservation of the sidelink resource 325-a via the coordination message 315. In some examples, however, the UE 115 may not receive one or more retransmissions of the resource reservation information (e.g., the UE 115 may not receive and decode each SCI 320 transmitted after the first SCI 320), which may reduce an accuracy of the count.

In another example, the UE 115 may identify a number of times that resource reservation information has been transmitted based on monitoring the one or more SCI 320 in the sidelink resources 305. The prioritization rules may indicate a threshold number of retransmissions (e.g., two retransmission, or some other number), and if the UE 115 determines that a same set of resource reservation information has been retransmitted in other SCI 320 more than the threshold number of times, the UE 115 may refrain from forwarding the resource reservation information. In some examples, the threshold number of retransmissions may be greater than one.

The prioritization rules for the UE 115 may thereby improve efficiency associated with sidelink resource reservation and selection. By selecting which resource reservation information to forward based on the prioritization rules, the UE 115 may forward relevant resource reservation information to one or more other UEs 115, which may improve communication reliability and reduce latency.

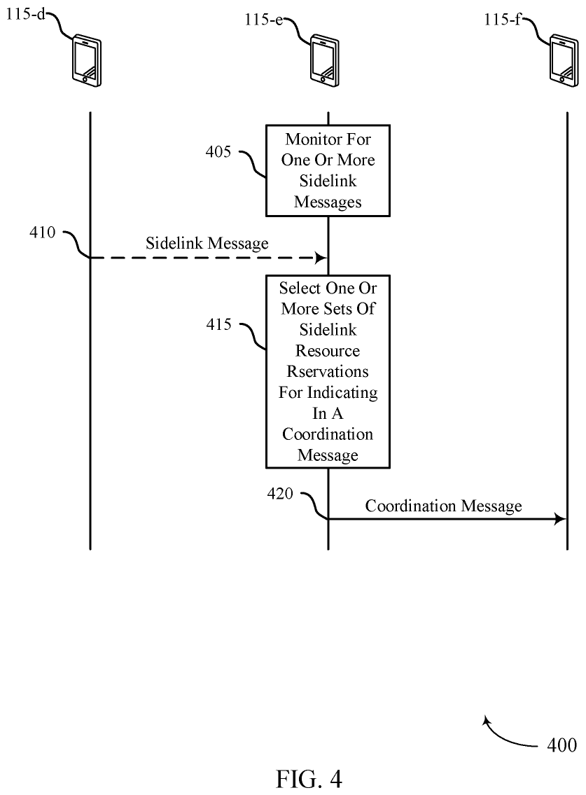

FIG. 4 illustrates an example of a process flow 400 that supports resource reservation prioritization for sidelink communications in accordance with aspects of the present disclosure. The process flow 400 may implement aspects of the wireless communications systems 100 and 200 or may be implemented by aspects of the wireless communications systems 100 and 200 as described with reference to FIGS. 1 and 2, respectively. For example, the process flow 400 may implement or be implemented by a UE 115-d, a UE 115-e, and a UE 115-f, which may be examples of UEs 115 as described with reference to FIGS. 1-3.

In the following description of the process flow 400, the operations between the UEs 115-d, 115-e, and 115-f may be performed in different orders or at different times. Some operations may also be left out of the process flow 400, or other operations may be added. Although UEs 115 are shown performing the operations of the process flow 400, some aspects of some operations may also be performed by one or more other wireless devices.

At 405, the UE 115-e may monitor for one or more sidelink messages that indicate a set of sidelink resource reservations associated with one or more other UEs 115. The one or more other UEs 115 may include as the UE 115-d. In some examples, monitoring for the one or more sidelink messages may include monitor resources within a sensing window for a sidelink message, as described with reference to FIG. 3.

At 410, in some examples, the UE 115-e may receive at least one sidelink message of the one or more sidelink messages from the UE 115-d. The sidelink message may be an example of a self-reservation message, an inter-UE coordination message, or some other sidelink message that indicates reservation of the set of sidelink resources associated with the UE 115-d. In some examples, the UE 115-e may additionally receive the one or more other sidelink messages from the one or more other UEs 115 (not pictured in FIG. 4).

At 415, the UE 115-e may select one or more sets of sidelink resource reservations for indicating in a coordination message in accordance with one or more prioritization rules for sidelink resource reservation forwarding based on the sidelink message.

At 420, the UE 115-e may transmit the coordination message to the UE 115-f, one or more other UEs 115, or both. The coordination message may include an indication of the one or more sets of sidelink resource reservations based on the selecting. The coordination message may be transmitted via RRC signaling, a MAC-CE, SCI (e.g., SCI-1 and/or SCI-2), or a combination thereof.

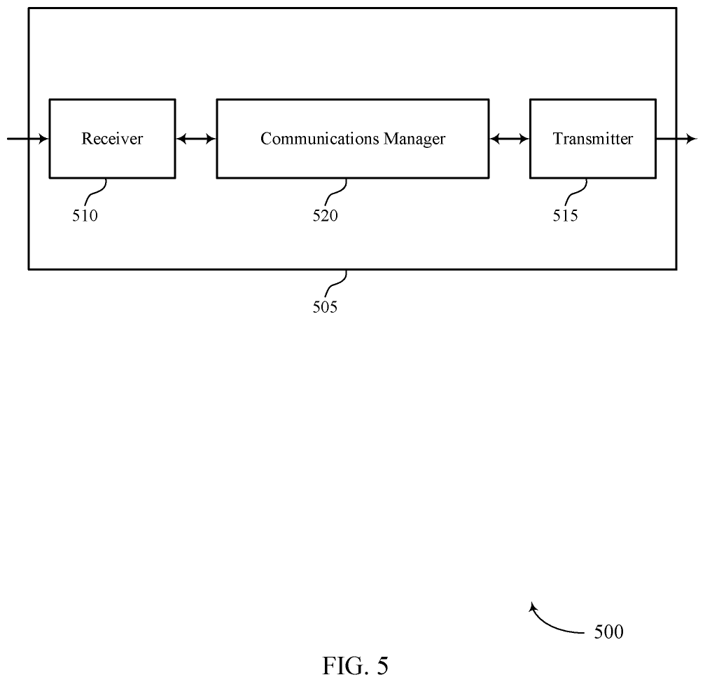

FIG. 5 shows a block diagram 500 of a device 505 that supports resource reservation prioritization for sidelink communications in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to resource reservation prioritization for sidelink communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to resource reservation prioritization for sidelink communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of resource reservation forwarding prioritization for sidelink communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first UE in accordance with examples as disclosed herein. For example, the communications manager 520 may be configured as or otherwise support a means for monitoring for one or more sidelink messages that indicate a set of sidelink resource reservations associated with one or more second UEs. The communications manager 520 may be configured as or otherwise support a means for selecting one or more sets of sidelink resource reservations for indicating in a coordination message in accordance with one or more prioritization rules for sidelink resource reservation forwarding based on a sidelink message of the one or more sidelink messages. The communications manager 520 may be configured as or otherwise support a means for transmitting the coordination message including an indication of the one or more sets of sidelink resources based on the selecting.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing, reduced power consumption, and more efficient utilization of communication resources. The device 505 may be configured with one or more rules for selecting which resource reservation information to forward to other devices. By forwarding resource reservation information and receiving resource reservation information forwarded from other devices, the processor of the device 505 may more accurately select resources for future transmissions, which may reduce processing and improve communication reliability. The one or more rules may provide for the processor of the device 505 to refrain from transmitting all of the resource reservation information that is received by the device 505, which may reduce processing and power consumption. Additionally or alternatively, the one or more rules may indicate which resource reservation information will be the most beneficial to forward to other devices, which may provide for the processor of the device 505 to support more efficient utilization of communication resources.

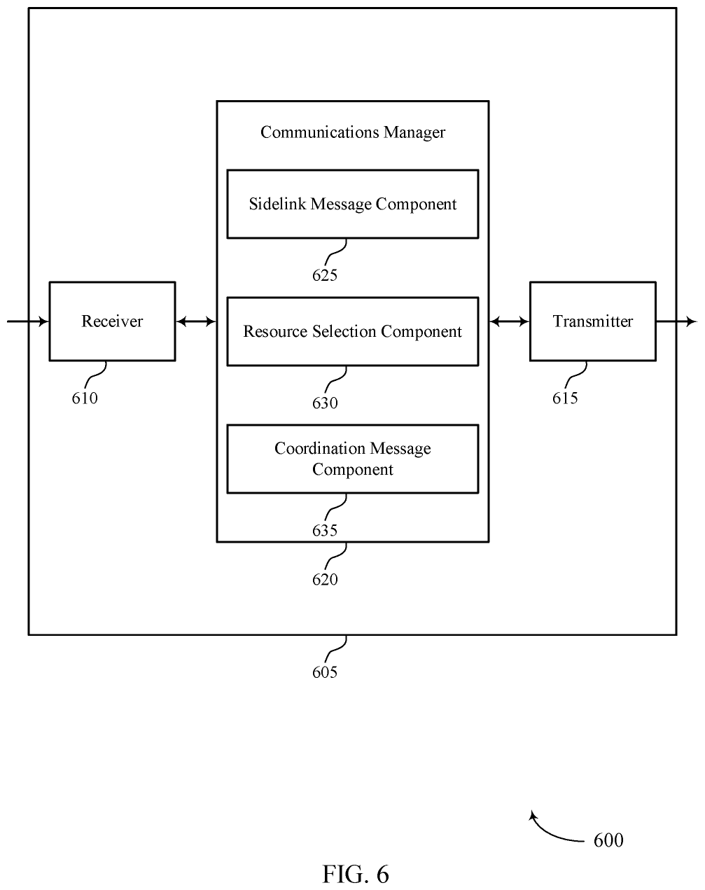

FIG. 6 shows a block diagram 600 of a device 605 that supports resource reservation prioritization for sidelink communications in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to resource reservation prioritization for sidelink communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to resource reservation forwarding prioritization for sidelink communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of resource reservation prioritization for sidelink communications as described herein. For example, the communications manager 620 may include a sidelink message component 625, a resource selection component 630, a coordination message component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first UE in accordance with examples as disclosed herein. The sidelink message component 625 may be configured as or otherwise support a means for monitoring for one or more sidelink messages that indicate a set of sidelink resource reservations associated with one or more second UEs. The resource selection component 630 may be configured as or otherwise support a means for selecting one or more sets of sidelink resource reservations for indicating in a coordination message in accordance with one or more prioritization rules for sidelink resource reservation forwarding based on a sidelink message of the one or more sidelink messages. The coordination message component 635 may be configured as or otherwise support a means for transmitting the coordination message including an indication of the one or more sets of sidelink resources based on the selecting.

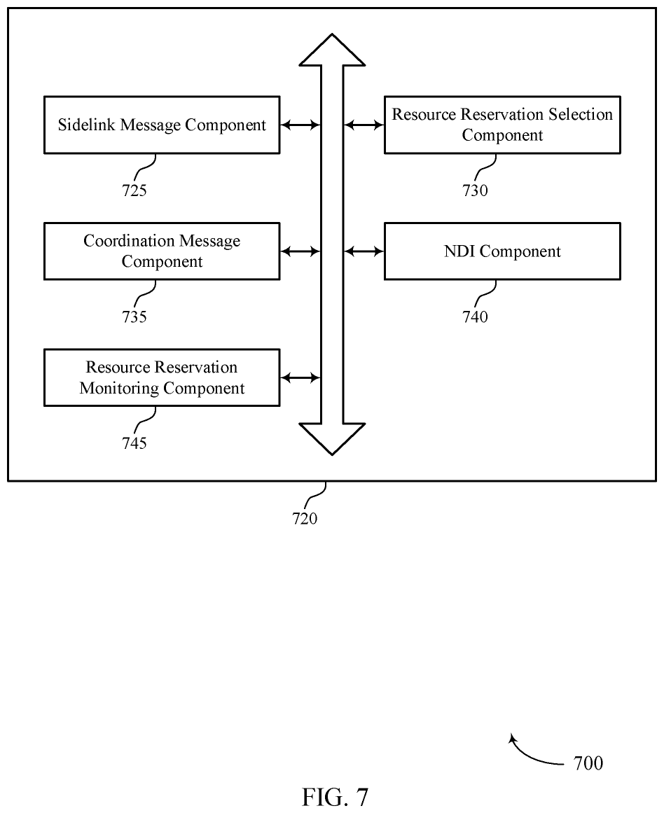

FIG. 7 shows a block diagram 700 of a communications manager 720 that supports resource reservation prioritization for sidelink communications in accordance with aspects of the present disclosure. The communications manager 720 may be an example of aspects of a communications manager 520, a communications manager 620, or both, as described herein. The communications manager 720, or various components thereof, may be an example of means for performing various aspects of resource reservation prioritization for sidelink communications as described herein. For example, the communications manager 720 may include a sidelink message component 725, a resource reservation selection component 730, a coordination message component 735, an NDI component 740, a resource reservation monitoring component 745, or any combination thereof. Each of these components may communicate, directly or indirectly, with one another (e.g., via one or more buses).

The communications manager 720 may support wireless communication at a first UE in accordance with examples as disclosed herein. The sidelink message component 725 may be configured as or otherwise support a means for monitoring for one or more sidelink messages that indicate a set of sidelink resource reservations associated with one or more second UEs. The resource reservation selection component 730 may be configured as or otherwise support a means for selecting one or more sets of sidelink resource reservations for indicating in a coordination message in accordance with one or more prioritization rules for sidelink resource reservation forwarding based on a sidelink message of the one or more sidelink messages. The coordination message component 735 may be configured as or otherwise support a means for transmitting the coordination message including an indication of the one or more sets of sidelink resources based on the selecting.

In some examples, to support selecting the one or more sets of sidelink resource reservations, the resource reservation selection component 730 may be configured as or otherwise support a means for selecting, in accordance with the one or more prioritization rules, the one or more sets of sidelink resource reservations based on a scheduled transmission time associated with the one or more sets of sidelink resource reservations, where the sidelink message indicates the scheduled transmission time.

In some examples, to support selecting the one or more sets of sidelink resource reservations, the resource reservation selection component 730 may be configured as or otherwise support a means for selecting, in accordance with the one or more prioritization rules, the one or more sets of sidelink resource reservations based on a difference between the scheduled transmission time and a delay period being greater than a threshold difference, the delay period based on a UE processing time and a first time associated with the selecting.

In some examples, the one or more sets of sidelink resource reservations exclude a first set of sidelink resource reservations based on a difference between a second scheduled transmission time associated with the first set of sidelink resource reservations and a delay period being less than zero, the delay period based on a UE processing time and a first time associated with the selecting.

In some examples, a UE processing time associated with the UE is based on a time for the UE to process the sidelink message and a type of signal used to receive the sidelink message.

In some examples, to support selecting the one or more sets of sidelink resource reservations, the resource reservation selection component 730 may be configured as or otherwise support a means for selecting at least the set of sidelink resource reservations based on the sidelink messages that indicates the set of sidelink resource reservations being received after other sidelink messages that indicate other sets of sidelink resource reservations.

In some examples, to support selecting the one or more sets of sidelink resource reservations, the resource reservation selection component 730 may be configured as or otherwise support a means for selecting at least the set of sidelink resource reservations based on a first slot in which the sidelink message that indicates the set of sidelink resource reservations is received being less than a threshold time period from a second slot in which the coordination message is scheduled.

In some examples, to support selecting the one or more sets of sidelink resource reservations, the resource reservation selection component 730 may be configured as or otherwise support a means for selecting at least the set of sidelink resource reservations based on a first slot in which the sidelink message that indicates the set of sidelink resource reservation is received being less than a threshold time period from a second slot that corresponds to a time at which the UE selects the set of sidelink resource reservations for indicating in the coordination message.

In some examples, to support selecting the one or more sets of sidelink resource reservations, the NDI component 740 may be configured as or otherwise support a means for selecting at least the set of sidelink resource reservations based on a value of an NDI in the sidelink message that indicates the set of sidelink resource reservations being set to one, where the NDI set to one indicates that the set of sidelink resource reservations is a first reservation of a set of sidelink resources used to transmit a sidelink communication. In some examples, the sidelink message indicating the set of sidelink resource reservations is received via SCI.

In some examples, the sidelink message component 725 may be configured as or otherwise support a means for receiving the one or more sidelink messages from the one or more second UEs, the one or more sidelink messages including inter-UE coordination messages.

In some examples, the resource reservation monitoring component 745 may be configured as or otherwise support a means for monitoring a quantity of times the set of sidelink resource reservations is forwarded via the inter-UE coordination messages. In some examples, the resource reservation selection component 730 may be configured as or otherwise support a means for selecting at least the set of sidelink resource reservations based on the quantity being less than a threshold quantity. In some examples, the resource reservation selection component 730 may be configured as or otherwise support a means for selecting the set of sidelink resource reservations based on the quantity being greater than or equal to one.

In some examples, to support transmitting the coordination message, the coordination message component 735 may be configured as or otherwise support a means for transmitting the coordination message via a PSSCH, where a quantity of the one or more sets of sidelink resource reservations indicated via the coordination message is based on a quantity of available resources in the PSSCH.

In some examples, to support transmitting the coordination message, the coordination message component 735 may be configured as or otherwise support a means for transmitting the coordination message via RRC signaling, a MAC-CE, SCI, or a combination thereof.

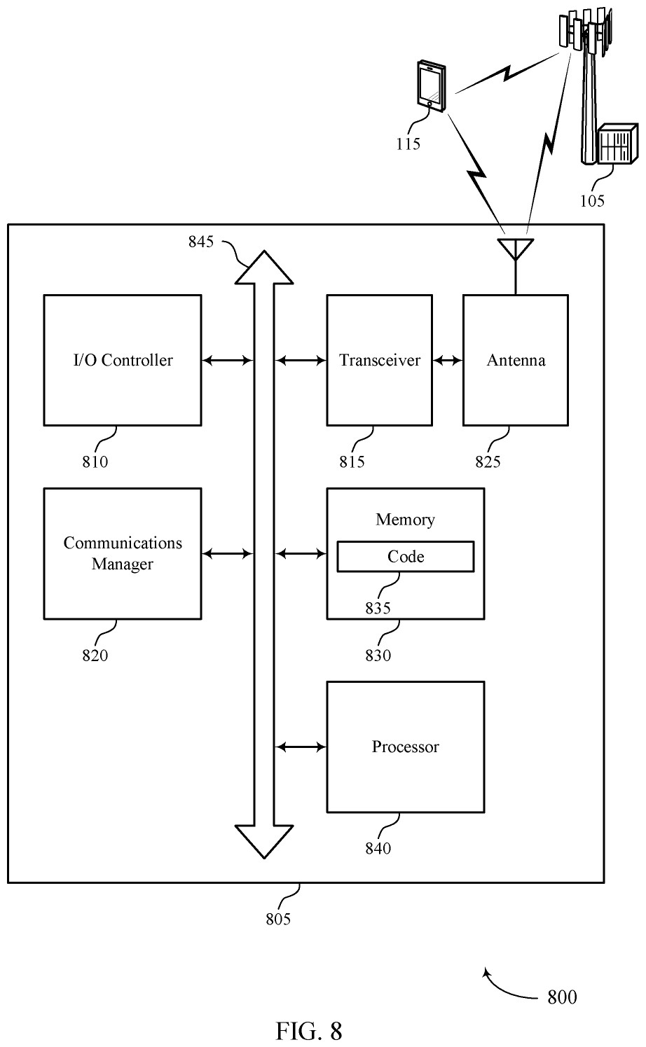

FIG. 8 shows a diagram of a system 800 including a device 805 that supports resource reservation prioritization for sidelink communications in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting resource reservation prioritization for sidelink communications). For example, the device 805 or a component of the device 805 may include a processor 840 and memory 830 coupled to the processor 840, the processor 840 and memory 830 configured to perform various functions described herein.

The communications manager 820 may support wireless communication at a first UE in accordance with examples as disclosed herein. For example, the communications manager 820 may be configured as or otherwise support a means for monitoring for one or more sidelink messages that indicate a set of sidelink resource reservations associated with one or more second UEs. The communications manager 820 may be configured as or otherwise support a means for selecting one or more sets of sidelink resource reservations for indicating in a coordination message in accordance with one or more prioritization rules for sidelink resource reservation forwarding based on a sidelink message of the one or more sidelink messages. The communications manager 820 may be configured as or otherwise support a means for transmitting the coordination message including an indication of the one or more sets of sidelink resource reservations based on the selecting.

By including or configuring the communications manager 820 in accordance with examples as described herein, the device 805 may support techniques for improved communication reliability, reduced latency, more efficient utilization of communication resources, and improved coordination between devices. The device 805 may forward resource reservation information that is received from other devices, which may improve communication reliability and coordination between devices. The device 805 may be configured with one or more rules for selecting which resource reservation information to forward, which may provide for more efficient utilization of communication resources. Additionally or alternatively, the one or more rules may provide for the device 805 to forward more important resource reservation information, which may reduce latency and improve communication reliability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of resource reservation prioritization for sidelink communications as described herein, or the processor 840 and the memory 830 may be otherwise configured to perform or support such operations.

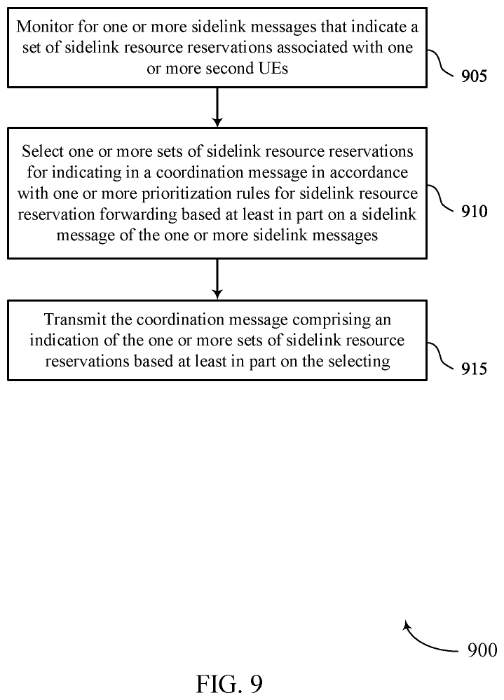

FIG. 9 shows a flowchart illustrating a method 900 that supports resource reservation prioritization for sidelink communications in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include monitoring for one or more sidelink messages that indicate reservations of a set of sidelink resources associated with one or more second UEs. The operations of 905 may be performed in accordance with examples as disclosed herein. In some examples, aspects of the operations of 905 may be performed by a sidelink message component 725 as described with reference to FIG. 7.

At 910, the method may include selecting one or more sets of sidelink resources reservations for indicating in a coordination message in accordance with one or more prioritization rules for sidelink resource reservation forwarding based on a sidelink message of the one or more sidelink messages indicating the sidelink resource reservation. The operations of 910 may be performed in accordance with examples as disclosed herein. In some examples, aspects of the operations of 910 may be performed by a resource reservation selection component 730 as described with reference to FIG. 7.

At 915, the method may include transmitting the coordination message including an indication of the one or more sets of sidelink resource reservations based on the selecting. The operations of 915 may be performed in accordance with examples as disclosed herein. In some examples, aspects of the operations of 915 may be performed by a coordination message component 735 as described with reference to FIG. 7.

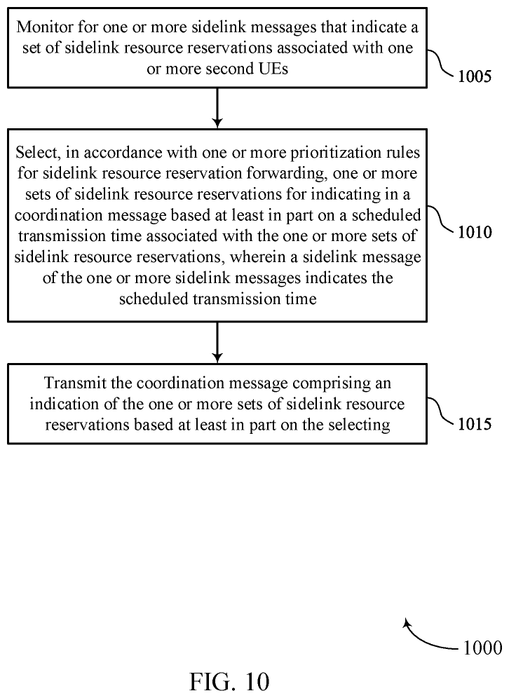

FIG. 10 shows a flowchart illustrating a method 1000 that supports resource reservation prioritization for sidelink communications in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include monitoring for one or more sidelink messages that indicate a set of sidelink resource reservations associated with one or more second UEs. The operations of 1005 may be performed in accordance with examples as disclosed herein. In some examples, aspects of the operations of 1005 may be performed by a sidelink message component 725 as described with reference to FIG. 7.

At 1010, the method may include selecting, in accordance with one or more prioritization rules for sidelink resource reservation forwarding, one or more sets of sidelink resource reservations for indicating in a coordination message based on a scheduled transmission time associated with the one or more sets of sidelink resource reservations, where a sidelink message of the one or more sidelink messages indicates the scheduled transmission time. The operations of 1010 may be performed in accordance with examples as disclosed herein. In some examples, aspects of the operations of 1010 may be performed by a resource reservation selection component 730 as described with reference to FIG. 7.

At 1020, the method may include transmitting the coordination message including an indication of the one or more sets of sidelink resource reservations based on the selecting. The operations of 1020 may be performed in accordance with examples as disclosed herein. In some examples, aspects of the operations of 1020 may be performed by a coordination message component 735 as described with reference to FIG. 7.

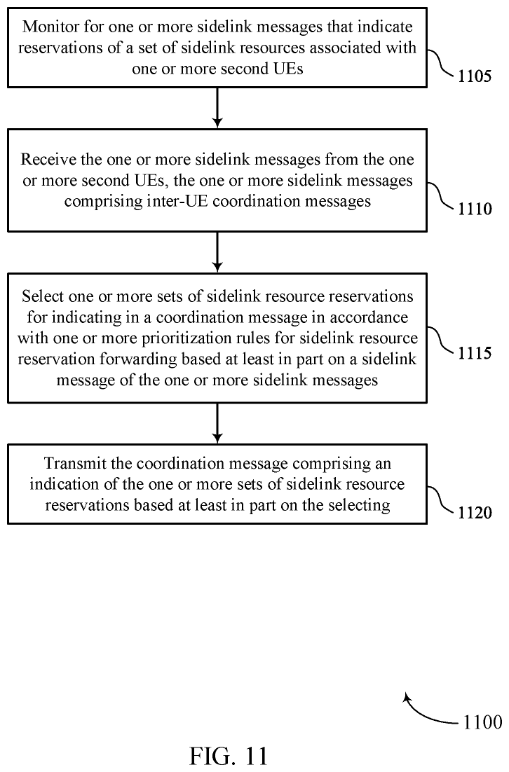

FIG. 11 shows a flowchart illustrating a method 1100 that supports resource reservation prioritization for sidelink communications in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include monitoring for one or more sidelink messages that indicate a set of sidelink resource reservations associated with one or more second UEs. The operations of 1105 may be performed in accordance with examples as disclosed herein. In some examples, aspects of the operations of 1105 may be performed by a sidelink message component 725 as described with reference to FIG. 7.

At 1110, the method may include receiving the one or more sidelink messages from the one or more second UEs, the one or more sidelink messages including inter-UE coordination messages. The operations of 1110 may be performed in accordance with examples as disclosed herein. In some examples, aspects of the operations of 1110 may be performed by a sidelink message component 725 as described with reference to FIG. 7.

At 1115, the method may include selecting one or more sets of sidelink resource reservations for indicating in a coordination message in accordance with one or more prioritization rules for sidelink resource reservation based on a sidelink message of the one or more sidelink messages. The operations of 1115 may be performed in accordance with examples as disclosed herein. In some examples, aspects of the operations of 1115 may be performed by a resource reservation selection component 730 as described with reference to FIG. 7.

At 1120, the method may include transmitting the coordination message including an indication of the one or more sets of sidelink resource reservations based on the selecting. The operations of 1120 may be performed in accordance with examples as disclosed herein. In some examples, aspects of the operations of 1120 may be performed by a coordination message component 735 as described with reference to FIG. 7.

The following provides an overview of aspects of the present disclosure:

Aspect 1: A method for wireless communication at a first UE, comprising: monitoring for one or more sidelink messages that indicate a set of sidelink resource reservations associated with one or more second UEs; selecting one or more sets of sidelink resource reservations for indicating in a coordination message in accordance with one or more prioritization rules for sidelink resource reservation forwarding based at least in part on a sidelink message of the one or more sidelink message; and transmitting the coordination message comprising an indication of the one or more sets of sidelink resource reservations based at least in part on the selecting.

Aspect 2: The method of aspect 1, wherein selecting the one or more sets of sidelink resource reservations comprises: selecting, in accordance with the one or more prioritization rules, the one or more sets of sidelink resource reservations based at least in part on a scheduled transmission time associated with the one or more sets of sidelink resource reservations, wherein the sidelink message indicates the scheduled transmission time.

Aspect 3: The method of aspect 2, wherein selecting the one or more sets of sidelink resource reservations comprises: selecting, in accordance with the one or more prioritization rules, the one or more sets of sidelink resource reservations based at least in part on a difference between the scheduled transmission time and a delay period being greater than a threshold difference, the delay period based at least in part on a UE processing time and a first time associated with the selecting.

Aspect 4: The method of any of aspects 2 through 3, wherein the one or more sets of sidelink resource reservations exclude a first set of sidelink resources based at least in part on a difference between a second scheduled transmission time associated with the first set of sidelink resource reservations and a delay period being less than zero, the delay period based at least in part on a UE processing time and a first time associated with the selecting.

Aspect 5: The method of any of aspects 2 through 4, wherein a UE processing time associated with the UE is based at least in part on a time for the UE to process the sidelink coordination message and a type of signal used to convey the sidelink coordination message.

Aspect 6: The method of aspect 1, wherein selecting the one or more sets of sidelink resource reservations comprises: selecting at least a set of sidelink resource reservations based at least in part on the sidelink message that indicates the set of sidelink resource reservations being received after other sidelink messages that indicate other sets of sidelink resource reservations.

Aspect 7: The method of aspect 1, wherein selecting the one or more sets of sidelink resource reservations comprises: selecting at least a set of sidelink resource reservations based at least in part on a first slot in which the sidelink message that indicates the set of sidelink resource reservations is received being less than a threshold time period from a second slot in which the coordination message is scheduled.

Aspect 8: The method of aspect 1, wherein selecting the one or more sets of sidelink resource reservations comprises: selecting at least a set of sidelink resource reservations based at least in part on a first slot in which the sidelink message that indicates the set of sidelink resource reservations is received being less than a threshold time period from a second slot that corresponds to a time at which the UE selects the set of sidelink resource reservations for indicating in the coordination message.

Aspect 9: The method of aspect 1, wherein selecting the one or more sets of sidelink resource reservations comprises: selecting at least a set of sidelink resource reservations based at least in part on a value of an NDI in the sidelink message that indicates the set of sidelink resource reservations being set to one, wherein the NDI set to one indicates that the set of sidelink resource reservations is a first reservation of a set of sidelink resources used to transmit a sidelink communication.

Aspect 10: The method of aspect 9, wherein the sidelink message that indicates the one or more sets of sidelink resource reservations is received via SCI.

Aspect 11: The method of any of aspects 1 through 10, further comprising: receiving the one or more sidelink messages from the one or more second UEs, the one or more sidelink messages comprising inter-UE coordination messages.

Aspect 12: The method of aspect 11, further comprising: monitoring a quantity of times a set of sidelink resource reservations is forwarded via the inter-UE coordination messages; and selecting at least the set of sidelink resource reservations based at least in part on the quantity being less than a threshold quantity.

Aspect 13: The method of aspect 12, further comprising: selecting the set of sidelink resource reservation based at least in part on the quantity being greater than or equal to one.

Aspect 14: The method of any of aspects 1 through 13, wherein transmitting the coordination message comprises: transmitting the coordination message via a PSSCH, wherein a quantity of the one or more sets of sidelink resource reservations indicated via the coordination message is based at least in part on a quantity of available resources in the PSSCH.

Aspect 15: The method of any of aspects 1 through 14, wherein transmitting the coordination message comprises: transmitting the coordination message via RRC signaling, a MAC-CE, SCI, or a combination thereof.

Aspect 16: An apparatus for wireless communication at a first UE, comprising a processor; memory coupled with the processor; and instructions stored in the memory and executable by the processor to cause the apparatus to perform a method of any of aspects 1 through 15.

Aspect 17: An apparatus for wireless communication at a first UE, comprising at least one means for performing a method of any of aspects 1 through 15.

Aspect 18: A non-transitory computer-readable medium storing code for wireless communication at a first UE, the code comprising instructions executable by a processor to perform a method of any of aspects 1 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a first user equipment (UE), comprising:
monitoring for one or more sidelink messages that indicate a set of sidelink resource reservations associated with one or more second UEs;
selecting one or more sets of sidelink resource reservations for indicating in a coordination message in accordance with one or more prioritization rules for sidelink resource reservation forwarding based at least in part on a sidelink message of the one or more sidelink messages; and
transmitting the coordination message comprising an indication of the one or more sets of sidelink resource reservations based at least in part on the selecting.

2. The method of claim 1, wherein selecting the one or more sets of sidelink resource reservations comprises:
selecting, in accordance with the one or more prioritization rules, the one or more sets of sidelink resource reservations based at least in part on a scheduled transmission time associated with the one or more sets of sidelink resource reservations, wherein the sidelink message indicates the scheduled transmission time.

3. The method of claim 2, wherein selecting the one or more sets of sidelink resource reservations comprises:
selecting, in accordance with the one or more prioritization rules, the one or more sets of sidelink resource reservations based at least in part on a difference between the scheduled transmission time and a delay period being greater than a threshold difference, the delay period based at least in part on a UE processing time and a first time associated with the selecting.

4. The method of claim 2, wherein the one or more sets of sidelink resource reservations exclude a first set of sidelink resource reservations based at least in part on a difference between a second scheduled transmission time associated with the first set of sidelink resource reservations and a delay period being less than zero, the delay period based at least in part on a UE processing time and a first time associated with the selecting.

5. The method of claim 2, wherein a UE processing time associated with the UE is based at least in part on a time for the UE to process the sidelink message and a type of signal used to convey the sidelink message.

6. The method of claim 1, wherein selecting the one or more sets of sidelink resource reservations comprises:
selecting at least a set of sidelink resource reservations based at least in part on the sidelink message that indicates the set of sidelink resource reservations being received after other sidelink messages that indicate other sets of sidelink resource reservations.

7. The method of claim 1, wherein selecting the one or more sets of sidelink resource reservations comprises:
selecting at least a set of sidelink resource reservations based at least in part on a first slot in which the sidelink message that indicates the set of sidelink resource reservations is received being less than a threshold time period from a second slot in which the coordination message is scheduled.

8. The method of claim 1, wherein selecting the one or more sets of sidelink resource reservations comprises:
selecting at least a set of sidelink resource reservations based at least in part on a first slot in which the sidelink message that indicates the set of sidelink resource reservations is received being less than a threshold time period from a second slot that corresponds to a time at which the UE selects the set of sidelink resource reservations for indicating in the coordination message.

9. The method of claim 1, wherein selecting the one or more sets of sidelink resource reservations comprises:
selecting at least a set of sidelink resource reservations based at least in part on a value of a new data indicator in the sidelink message that indicates the set of sidelink resource reservations being set to one, wherein the new data indicator set to one indicates that the set of sidelink resource reservations is a first reservation of a set of sidelink resources used to transmit a sidelink communication.

10. The method of claim 9, wherein the sidelink message that indicates the one or more sets of sidelink resource reservations is received via sidelink control information.

11. The method of claim 1, further comprising:
receiving the one or more sidelink messages from the one or more second UEs, the one or more sidelink messages comprising inter-UE coordination messages.

12. The method of claim 11, further comprising:
monitoring a quantity of times a set of sidelink resource reservations is forwarded via the inter-UE coordination messages; and
selecting at least the set of sidelink resource reservations based at least in part on the quantity being less than a threshold quantity.

13. The method of claim 12, further comprising:
selecting the set of sidelink resource reservations based at least in part on the quantity being greater than or equal to one.

14-15. (canceled)

16. An apparatus for wireless communication at a first user equipment (UE), comprising:
one or more processors;
one or more memories coupled with the one or more processors; and
instructions stored in the one or more memories and executable by the one or more processors to cause the apparatus to:
monitor for one or more sidelink messages that indicate a set of sidelink resource reservations associated with one or more second UEs;
select one or more sets of sidelink resource reservations for indicating in a coordination message in accordance with one or more prioritization rules for sidelink resource reservation forwarding based at least in part on a sidelink message of the one or more sidelink messages; and
transmit the coordination message comprising an indication of the one or more sets of sidelink resource reservations based at least in part on the selecting.

17. The apparatus of claim 16, wherein the instructions to select the one or more sets of sidelink resource reservations are executable by the one or more processors to cause the apparatus to:
select, in accordance with the one or more prioritization rules, the one or more sets of sidelink resource reservations based at least in part on a scheduled transmission time associated with the one or more sets of sidelink resource reservations, wherein the sidelink message indicates the scheduled transmission time.

18. The apparatus of claim 17, wherein the instructions to select the one or more sets of sidelink resource reservations are executable by the one or more processors to cause the apparatus to:
select, in accordance with the one or more prioritization rules, the one or more sets of sidelink resource reservations based at least in part on a difference between the scheduled transmission time and a delay period being greater than a threshold difference, the delay period based at least in part on a UE processing time and a first time associated with the selecting.

19. The apparatus of claim 17, wherein the one or more sets of sidelink resource reservations exclude a first set of sidelink resource reservations based at least in part on a difference between a second scheduled transmission time associated with the first set of sidelink resource reservations and a delay period being less than zero, the delay period based at least in part on a UE processing time and a first time associated with the selecting.

20. The apparatus of claim 17, wherein a UE processing time associated with the UE is based at least in part on a time for the UE to process the sidelink message and a type of signal used to receive the sidelink message.

21. The apparatus of claim 16, wherein the instructions to select the one or more sets of sidelink resource reservations are executable by the one or more processors to cause the apparatus to:
select at least the set of sidelink resource reservations based at least in part on the sidelink message being received after other sidelink messages that indicate other sets of sidelink resource reservations.

22. The apparatus of claim 16, wherein the instructions to select the one or more sets of sidelink resource reservations are executable by the one or more processors to cause the apparatus to:
select at least the set of sidelink resource reservations based at least in part on a first slot in which the sidelink message is received being less than a threshold time period from a second slot in which the coordination message is scheduled.

23. The apparatus of claim 16, wherein the instructions to select the one or more sets of sidelink resource reservations are executable by the one or more processors to cause the apparatus to:
select at least the set of sidelink resource reservations based at least in part on a first slot in which the sidelink message is received being less than a threshold time period from a second slot that corresponds to a time at which the UE selects the set of sidelink resource reservations for indicating in the coordination message.

24. The apparatus of claim 16, wherein the instructions to select the one or more sets of sidelink resource reservations are executable by the one or more processors to cause the apparatus to:
select at least the set of sidelink resource reservations based at least in part on a value of a new data indicator in the sidelink message that indicates the set of sidelink resource reservations being set to one, wherein the new data indicator set to one indicates that the set of sidelink resource reservations is a first reservation of a set of sidelink resources used to transmit a sidelink communication.

25. The apparatus of claim 24, wherein the sidelink message is received via sidelink control information.

26. The apparatus of claim 16, wherein the instructions are further executable by the one or more processors to cause the apparatus to:
receive the one or more sidelink messages from the one or more second UEs, the one or more sidelink messages comprising inter-UE coordination messages.

27. The apparatus of claim 26, wherein the instructions are further executable by the one or more processors to cause the apparatus to:
monitor a quantity of times the set of sidelink resource reservations is forwarded via the inter-UE coordination messages; and
select at least the set of sidelink resource reservations based at least in part on the quantity being less than a threshold quantity.

28. The apparatus of claim 27, wherein the instructions are further executable by the one or more processors to cause the apparatus to:
select the set of sidelink resource reservations based at least in part on the quantity being greater than or equal to one.

29. The apparatus of claim 16, wherein the instructions to transmit the coordination message are executable by the one or more processors to cause the apparatus to:
transmit the coordination message via a physical sidelink shared channel, wherein a quantity of the one or more sets of sidelink resource reservations indicated via the coordination message is based at least in part on a quantity of available resources in the physical sidelink shared channel.

30. The apparatus of claim 16, wherein the instructions to transmit the coordination message are executable by the one or more processors to cause the apparatus to:
transmit the coordination message via radio resource control signaling, a medium access control-control element, sidelink control information, or a combination thereof.

31. An apparatus for wireless communication at a first user equipment (UE), comprising:
means for monitoring for one or more sidelink messages that indicate a set of sidelink resource reservations associated with one or more second UEs;
means for selecting one or more sets of sidelink resource reservations for indicating in a coordination message in accordance with one or more prioritization rules for sidelink resource reservation forwarding based at least in part on a sidelink message of the one or more sidelink messages; and
means for transmitting the coordination message comprising an indication of the one or more sets of sidelink resource reservations based at least in part on the selecting.

32-45. (canceled)

46. A non-transitory computer-readable medium storing code for wireless communication at a first user equipment (UE), the code comprising instructions executable by one or more processors to:
monitor for one or more sidelink messages that indicate a set of sidelink resource reservations associated with one or more second UEs;
select one or more sets of sidelink resource reservations for indicating in a coordination message in accordance with one or more prioritization rules for sidelink resource reservation forwarding based at least in part on a sidelink message of the one or more sidelink messages; and
transmit the coordination message comprising an indication of the one or more sets of sidelink resource reservations based at least in part on the selecting.

47-60. (canceled)
